(19) United States
(12) Patent Application Publication
(10) Pub. No.: US 2026/0220464 A1
(43) Pub. Date: Jul. 30, 2026

(54) END TO END LEARNING OF COMPONENTS WITHIN A SYSTEM FOR DRIVING

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 19/037,626

(22) Filed: Jan. 27, 2025

(51) Int. Cl. G06N 3/082; B60W 50/00; B60W 60/00; G06N 3/084; G06N 3/0985

(52) U.S. Cl. CPC G06N 3/082; B60W 50/00; G06N 3/084; G06N 3/0985; B60W 60/00

(57) ABSTRACT

A method of training of components within a system for driving, the method includes identifying, by a computerized system, a module in a stack of modules, wherein the identified module is distilled in accordance with a specified driving scenario; freezing at least part of the other modules of the stack; and autonomously training, by the computerized system, the module in an end-to-end training, to contribute to a provision of a driving related decision by the stack of modules, by using a loss function determined based on an output coming out of the stack of modules. The autonomously training of the module, within the stack, occurs while at the least part of the other modules of the stack are in a frozen state.

### BACKGROUND

Autonomous driving requires information (such as information sensed by one or more sensors related to an autonomous vehicle) and generates driving related decisions. An artificial intelligence model that receives such information and generated driving related decisions is referred to as an end to end artificial intelligence model.

Current general-purpose end to end artificial intelligence models are vary large, require extensive amounts of information for training, and their training and/or fine tuning is very costly.

There is a growing need to provide solutions for autonomous driving that are compact and easy to train.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIGS. 3-7 illustrate example of distillation and/or training of a stack;

FIG. 8 illustrates an example of a computerized system;

FIG. 9 illustrates an example of a method; and

FIG. 10 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

According to an embodiment there is provided a method for generating a stack of modules that is very compact, easy to train and benefits from the accuracy of much larger stacks.

According to an embodiment, a module is a hardware circuit (such as a processing circuit) or set of instructions or code or firmware that is executable by a hardware processor. Examples of a module include a rule-based model, an artificial intelligence model, a neural network, a tunable model, a learnable model, a non-tunable module, a non-learnable module, a neural network, and the like. According to an embodiment, a module is a function executable by a hardware processor, or a hardware circuit configured to implement the function. The function may be learnable or not learnable.

According to an embodiment, the modules of the stack are tuned during the generating of the stack. According to an embodiment, only one or some (but not all) of modules of the stack are tuned during the generation of the stack.

According to an embodiment, the stack is compact as it includes modules that have been distilled in accordance with a specified driving scenario to provide modules that function as much larger initial modules that were distilled to provide the modules of the stack. According to an embodiment the distilled modules is a neural network or an artificial intelligence process that is smaller by a factor of two till twenty—especially ten that the larger initial modules that is a neural network or an artificial intelligence process. For example—a larger initial module was a neural network having ten million parameters and the distilled module is a neural network has one million parameters. The number of parameters of the distilled module may differ from one million. The number of parameters of the larger initial module may differ from ten million. An initial stack may include a mixture of rule-based modules and neural networks. An initial stack may be an end to end stack or not an end to end stack.

According to an embodiment, one or more modules of the stack are individually trained within the stack using a loss function that considers the output of the stack—thereby improving the accuracy of the stack at a much smaller number of training iterations (or at a fraction of the training cost) in comparison to solely simultaneously training all the modules at once. During an individually training of a module within the stack other modules are not amended—either because they are non-learnable models or frozen—either by explicitly preventing them from being changed or by not being included in a backpropagation path.

According to an embodiment, a specified module that has to maintain unamended while another module of the stack is individually trained within the stack exhibits non-learnable parameters then there is no need to freeze the specified module during the individually training of the other module.

According to an embodiment, a specified module that has to maintain unamended while another module of the stack is individually trained within the stack exhibits one or more learnable parameters then there it may be maintained frozen during the individually training of the other module.

According to an embodiment, said mentioned above specified module may be a rule-based module or a neural network.

According to an embodiment, all modules or only some of the modules of the stack may be frozen.

According to an embodiment, the loss function output is not fed directly to the individually trained module—but is backpropagated through one or more modules that are referred to downstream modules.

According to an embodiment, a backstream module is configured to convey the loss function output backwards without being modified.

According to an embodiment, the backstream modules form a deep learning framework that allows for backpropagation of data. See, for example, the section of the application titled Convert Rule-Based Components to PyTorch.

According to an embodiment the accuracy of the stack is further improved by performing, following a completion of the individually training of the modules within the stack, of a collaborative learning (co-learning) of the different modules of the stack—thereby further improving the accuracy of the stack.

The combination of the individually training of modules and then performing the col-learning provides a highly accurate stack that was trained by a much smaller number of training iterations (or at a fraction of the training cost)in comparison to solely simultaneously training all the modules at once.

According to an embodiment, and in order to reduce the training cost by selecting which modules should be individually trained. The selection may be based on the ratio between the benefit to the accuracy of the stack and the cost of the individually training. This may amount to select only the one of few modules that their individually training mostly benefits the stack. This selection may be based on tests and/or simulations and/or estimates regarding the modules that their individually training will most benefit the stack.

According to an embodiment, following the co-learning, the method also include melting the modules of the stack into a monolithic structure.

According to an embodiment a stack includes perception and path planning capabilities.

According to an embodiment, the stack includes perception, prediction, and path planning. Perception includes object detection and involved obtaining sensed information such as images and outputs bounding boxes for objects. Prediction uses the detected objects' positions and velocities to predict their future trajectories. Path planning includes combining predicted trajectories and current road conditions to produce a planned trajectory and speed profile for the ego vehicle.

According to an embodiment, the stack also include a driver controller unit that is configured to convert the planned trajectory and speed profile for the autonomous vehicle to instructions and/or commands and/or requests to move the autonomous vehicle according to the planned trajectory and speed profile.

According to an embodiment, the stack does not include the driver controlling unit.

According to an embodiment there are provided multiple stacks—each being generated in relation to a different specified scenario. At least some of the stacks share the same topology or architecture—while some other stacks share another topology or architecture.

According to an embodiment, the different stacks may form an ensemble or a group of a set of narrow AI agents and may be selectively used when an autonomous vehicle faces different scenarios or scenes. Examples of an ensemble of narrow Artificial Intelligence agents—one or more examples are illustrated in any one of following applications—all being incorporated herein by reference—U.S. patent application Ser. No. 17/817,928 filing date Aug. 5, 2022; U.S. patent application Ser. No. 17/817,935 filing date Aug. 5, 2022; U.S. patent application Ser. No. 18/036,150 filing date Apr. 15, 2021; U.S. patent application Ser. No. 18/459,416 filing date Aug. 13, 2023.

According to an embodiment, the ensemble of narrow AI agents are preceded by a perception unit or a perception router that determined the scenario faced by the vehicle and sends at least sensed information to one or more relevant stacks associated with the scenario. The one or more stacks output one or more driving related decisions that may be outputted to other autonomous vehicle components or units—or may be fed to an output unit that will generate, based on the one or more driving related decisions of the one or more stack, one or more output driving related decisions that may be outputted to other autonomous vehicle components or units.

According to an embodiment, a module that should be tuned during the generating of the stack and has initially an un-tuned configuration or format is converted to a tunable format. For example—a model that is rule-based and non-tunable may be converted to a neural network of any other tunable model.

According to an embodiment the converting includes converting rule-based modules that are not differentiable to differential modules so that the loss function used in training the differential modules may be a differential loss function so that gradients are back-propagated through the differential modules.

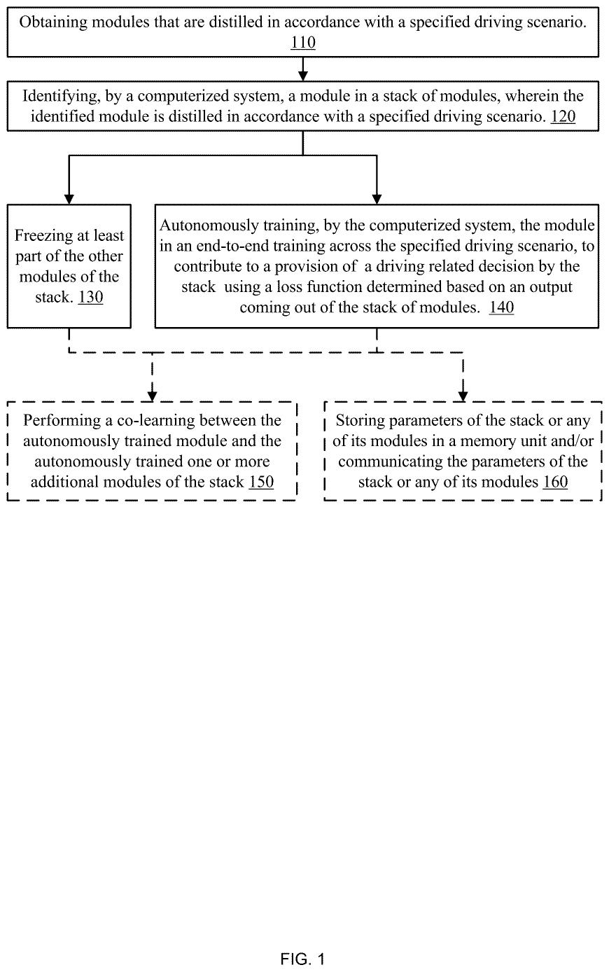

FIG. 1 illustrates an example of a method 100 of training of components within a system for driving.

According to an embodiment method 100 start by an initialization step 110 of obtaining modules that are distilled in accordance with a specified driving scenario. The obtaining includes receiving the modules following the specific driving scenario distillation or distilling the modules.

According to an embodiment, a module is distilled in accordance with the specified driving scenario, based on identified driving related data pertaining to the specified driving scenario.

According to an embodiment, the distilled module is a student module that is associated with a much larger teacher module—such as non-scenario specific artificial intelligence module. The distillation process includes feeding the student module and the teacher module with a dataset that consist or consists essentially of information related to the specific driving scenario. Thus—the dataset does not include or substantially does not include information elated to another specific scenario.

According to an embodiment, the distillation includes receiving outputs from the student module and the teacher module, calculating a distillation loss function that minimizes the difference between the outputs from the student module and the teacher module, and amending the student module according to the loss function.

It has been surprisingly found that while distillation of general-purpose modules to smaller modules is associated with loss of accuracy—then distillation that is limited to a specified driving scenario dramatically increases the accuracy and may provide a scenario specific distilled module that accurately mimics the much larger general purpose nodule.

According to an embodiment initialization step 110 is followed by step 120 of identifying, by a computerized system, a module in a stack of modules, wherein the identified module is distilled in accordance with a specified driving scenario.

According to an embodiment, the identifying include searching for a module to be individually trained within the stack based on the ratio between the benefit to the accuracy of the stack and the cost of the individually training.

According to an embodiment, the identifying includes selecting the next module out of two or modules that were defined (in any manner) to be tuned.

According to an embodiment, step 120 is followed by step 130 of freezing at least part of the other modules of the stack.

According to an embodiment, the freezing includes preventing from changing the at least part of the other modules of the stack.

According to an embodiment, a freezing of a module is performed by at least one of:
executing instructions that do not allow to change the frozen module.
limiting the backpropagation from reaching the frozen module.

According to an embodiment step 120 is also followed by step 140 of autonomously training, by the computerized system, the module in an end-to-end training across the specified driving scenario, to contribute to a provision of a driving related decision by the stack of modules, by using a loss function determined based on an output coming out of the stack of modules. The autonomously training of the module, within the stack, occurs while at the least part of the other modules of the stack are in a frozen state.

According to an embodiment the loss function is further determined by imitation learning of a human driving behavior facing the specified driving scenario. For example—the loss function is determined based on the relationship (for example difference) between the actual output of the stack and a desired output that represent the human driving behavior.

According to an embodiment the stack includes a driving controller unit, and the autonomously training is by using the loss function determined based on the output coming out of the driving controller unit of the stack of modules.

According to an embodiment the output of the stack is provided by the path planner module and the autonomously training is by using the loss function determined based on the output coming out of path planner module of the stack of modules.

According to an embodiment step 140 involves backpropagating the output of the loss function through one or more downstream modules of the stack till reaching the identified module.

According to an embodiment, steps 110, 120, 130 and 140 are repeated a plurality of times for autonomously training within the stack a plurality of modules of the stack.

According to an embodiment, once the autonomously training ends, the method proceeds to step 150 of performing a co-learning between the autonomously trained module and the autonomously trained one or more additional modules of the stack. In step 150 the modules are not frozen.

According to an embodiment, step 140 and/or step 150 are followed by step 160 of storing parameters of the stack or any of its modules in a memory unit and/or communicating the parameters of the stack or any of its modules.

According to an embodiment, once the stack has been trained it is used during inference to generate a driving related decision.

According to an embodiment, the driving related decision is converted to instructions and/or commands and/or requests to move the autonomous vehicle according to the planned trajectory and speed profile.

According to an embodiment the driving related decision includes instructions and/or commands and/or requests to move the autonomous vehicle according to the planned trajectory and speed profile.

According to an embodiment any driving related decision generated by any computerized system (either included in the ground vehicle copilot or not) may include or may be converted to (by a computerized system of the ground vehicle or by another computerized system) a request and/or a determining of an instruction and/or an instruct and/or a trigger and/or a control of and/or a performance of an autonomous driving related operation of the ground vehicle. The driving related decision may be related to a velocity and/or acceleration and/or direction of movement of the ground vehicle at one or more points in time. According to an embodiment, the driving related decision is aimed to one or more ground vehicle components such as brakes, clutch, engine, gear, or any other component that sets the velocity and/or acceleration and/or direction of movement of the ground vehicle.

According to an embodiment any driving related decision generated by any computerized system is in compliant with one or more levels of autonomous driving-such as L2, L2+, L2++, L3 or L4 autonomous driving.

According to an embodiment the driving related decision is a planned trajectory and speed profile for the autonomous vehicle.

An example of a module conversion and a training of a stack are provided below.

Starting with an initial stack that processes inputs and produces a trajectory and speed profile having a perception module that takes raw camera images and outputs bounding boxes for objects, a prediction module that uses the detected objects' positions and velocities to predict their future trajectories, and a planning module that combines predicted trajectories and current road conditions to produce a planned trajectory and speed profile for the ego vehicle. Here, the planning module outputs the final trajectory and speed profile, which is the end result of the entire stack.

The object detection model operates on raw images and outputs structured data (bounding boxes, object classes). It forms the granular, differentiable module that will be trained end-to-end using gradients propagated back through the rule-based components.

Assuming that the conversion is based on using the PyTorch library which supports a deep learning format.

### Convert Rule-Based Components to PyTorch

Since rule-based components are typically non-differentiable, you need to rewrite them in PyTorch while maintaining their original functionality.

### Prediction Module

Classical approach: Use a rule-based model (e.g., constant velocity or constant acceleration) to extrapolate object trajectories.
PyTorch rewrite:
   i. Represent object motion using a differentiable mathematical model, such as: xt+1=xt+vt·Δt where xt is the object's position, vt is its velocity, and At is the time step.
   ii. Add differentiable loss terms, such as trajectory smoothness or accuracy compared to ground truth.

### Planning Module

Classical approach: Rule-based planners often compute trajectories by minimizing pre-defined costs (e.g., distance to lane center, collision risk).
PyTorch rewrite:
Implement a differentiable cost function that captures the planner's objectives: Cost=λ1·Lane Deviation+λ2·Collision Risk+λ3·Trajectory Smoothness
Use a differentiable solver, like gradient descent or differentiable quadratic programming layers, to compute the optimal trajectory.

### Train the Object Detection Module “End-to-End”

Forward Pass
   i. Feed raw images into the object detection model to output bounding boxes and classifications.
   ii. Pass the detected objects to the differentiable prediction module, which generates future trajectories for each object.
   iii. Use the predicted object trajectories in the differentiable planning module to compute a planned trajectory and speed profile for the ego vehicle.
Loss Function Construction
   i. Design a composite loss function to train the object detection model end-to-end:
Trajectory and Speed Profile Loss
   i. Measure the difference between the planned trajectory/speed profile and the ground truth trajectory from human driving data: Ltrajectory=MSE(yplanned,yhuman)
Auxiliary Detection Loss:
Include standard detection losses for bounding boxes and classifications to retain object detection accuracy: Ldetection=Lbbox+Lclassification
Total Loss: Ltotal=λ1·Ltrajectory+λ2·Ldetection
Backward Pass
   i. Compute gradients for the total loss with respect to the object detection model parameters.
Propagate these gradients through the prediction and planning modules, which are now differentiable.
Update the object detection model's weights using gradient descent.

### Benefits of Backpropagation Through Rule-Based Modules

Task-Specific Optimization: the object detection model is optimized for downstream objectives (e.g., trajectory accuracy), not just for standalone detection performance.
Seamless Integration: by converting rule-based modules to PyTorch, the entire stack becomes differentiable, allowing for smoother error propagation.

According to an embodiment, the stack is configured to calculate signatures and/or embeddings—one or more examples are illustrated in any one of following applications—all being incorporated herein by reference—U.S. patent application Ser. No. 16/729,589 filing date Dec. 20, 2019, PCT patent application PCT/IB 2019/058207 filing date Sep. 27, 2019.

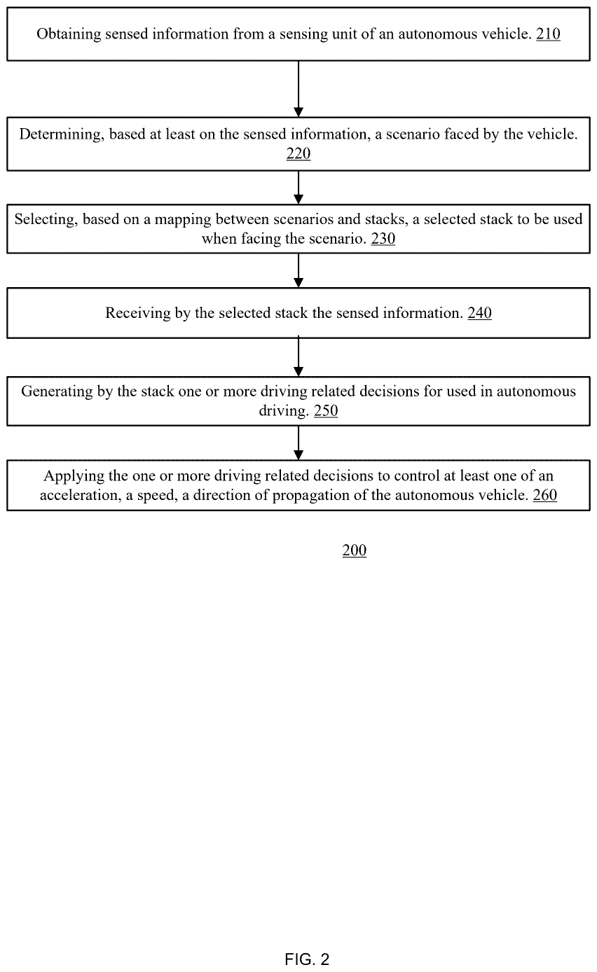

FIG. 2 illustrates method 200 for inference using a stack.

According to an embodiment method 200 starts by step 210 of obtaining sensed information from a sensing unit of an autonomous vehicle.

According to an embodiment step 210 is followed by step 220 of determining, based at least on the sensed information, a scenario faced by the vehicle.

According to an embodiment, step 220 is followed by step 230 of selecting, based on a mapping between scenarios and stacks, a selected stack to be used when facing the scenario.

According to an embodiment, step 230 is followed by step 240 of receiving by the selected stack the sensed information.

According to an embodiment, step 240 is followed by step 250 of generating by the stack one or more driving related decisions for used in autonomous driving. Wherein the stack was generated using method 100.

According to an embodiment, step 250 is followed by step 260 of applying the one or more driving related decisions to control at least one of an acceleration, a speed, a direction of propagation of the autonomous vehicle.

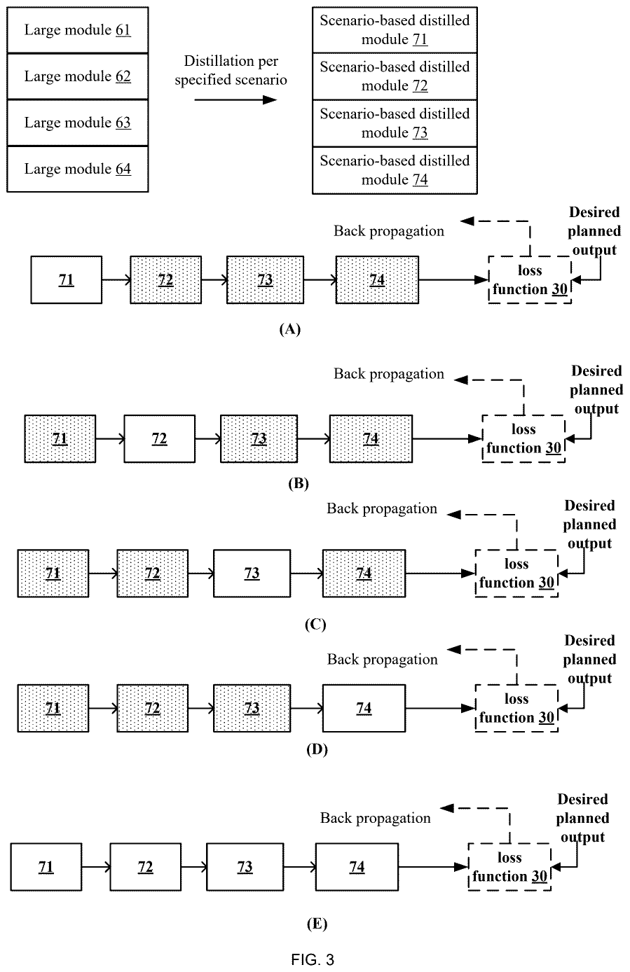

FIG. 3 illustrates an example of distillation per specified module of large modules 61-64 to provide scenario-based distilled modules 71, 72, 72 and 73.

It is assumed that scenario-based distilled module 71 is a perception module, scenario-based distilled module 72 is a prediction module, scenario-based distilled module 73 is a path planning module and scenario-based distilled module 74 is a driver controller unit.

Examples A-D illustrates four repetitions of autonomous training each one of the scenario-based distilled modules within the stack while other scenario-based distilled modules are frozen. The autonomous training uses a loss function 30.

Example E illustrates a co-learning in which the entire stack is being trained, and all modules can be adapted—they are not frozen.

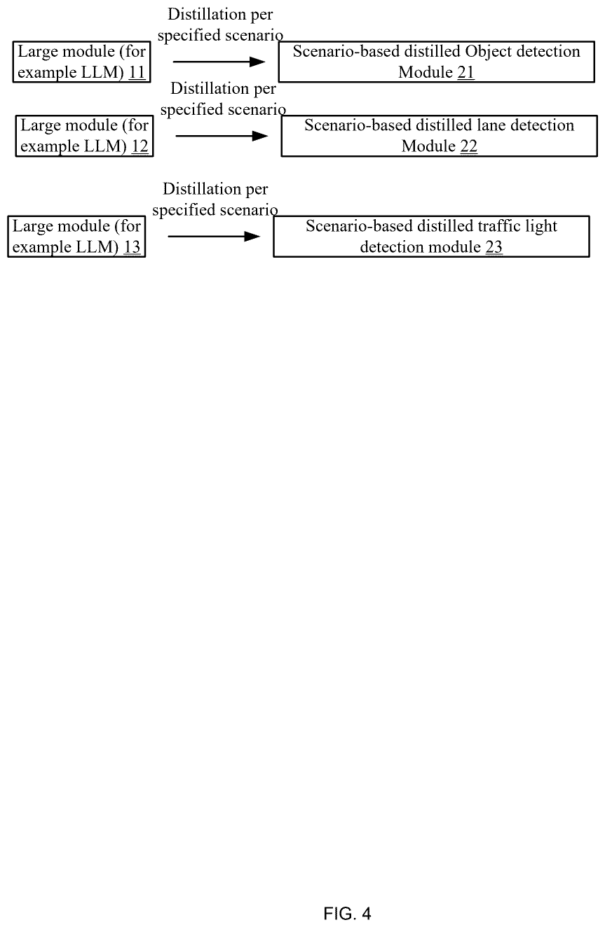

FIG. 4 illustrated an example of distilling scenario-based distilled module such as scenario-based distilled object detection module 21, scenario-based distilled lane detection module 22, and scenario-based distilled traffic light detection module 23—all being examples of perception modules.

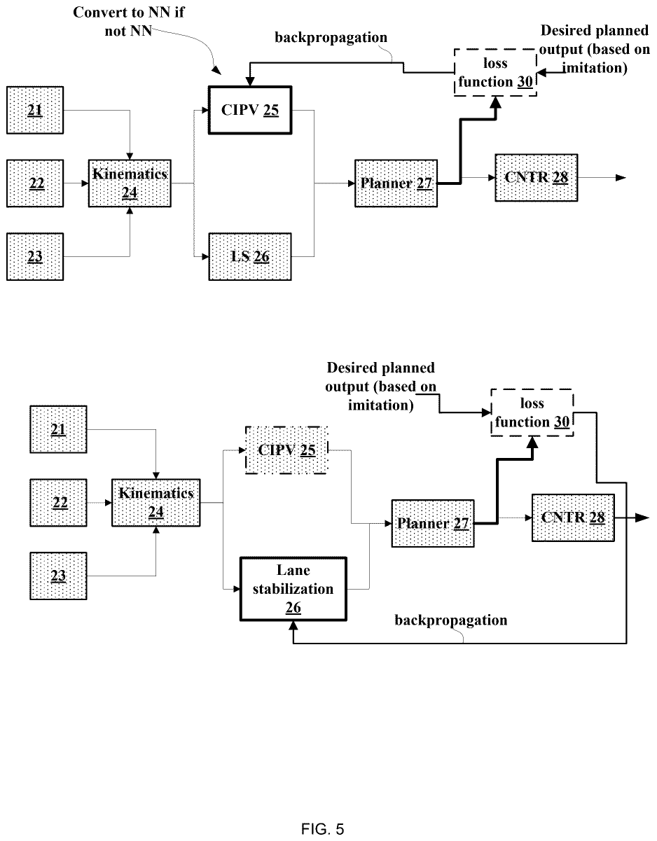

FIG. 5-7 illustrate one or more stacks that are aimed for a scenario in which an autonomous vehicle drives along a single lane road and behind the closest vehicle.

The one or more stacks of FIGS. 5-7 include:
Perception modules such as scenario-based distilled object detection module 21, scenario-based distilled lane detection module 22, and scenario-based distilled traffic light detection module 23.
A kinematic module 24 (denoted kinematics) that determined movement of detected elements detected by the perception modules-based on sensed information acquired at multiple points in time.
A lane stabilization module (denoted LS) 26.
A closest in path vehicle (CIPV) module 25.
A path planning module (denoted planner) 27.

In some example the stack also includes driver controller unit (denoted CNTR) 28, and in some examples the driver controller unit is not a part of the stack.

According to an embodiment, one or more modules of the stack are scenario-based distilled.

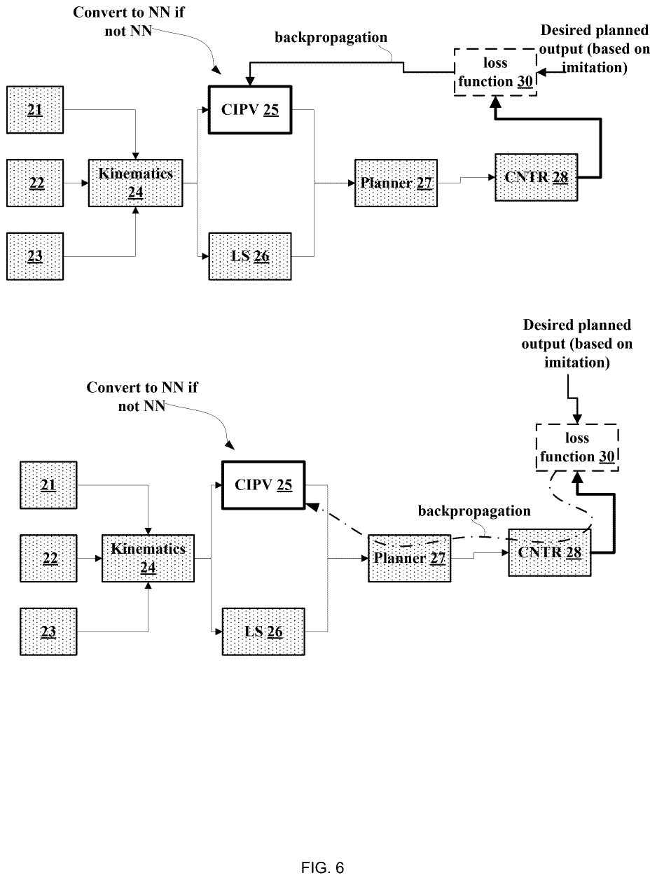

FIGS. 5-6 illustrate repetitions of autonomous training each one of the scenario-based distilled modules within the stack while other scenario-based distilled modules are frozen.

The autonomous training uses a loss function 30 in which the output of the loss function is either fed to autonomously trained module or fed to the output of the stack or backpropagated from the output of the stack to the autonomously trained module.

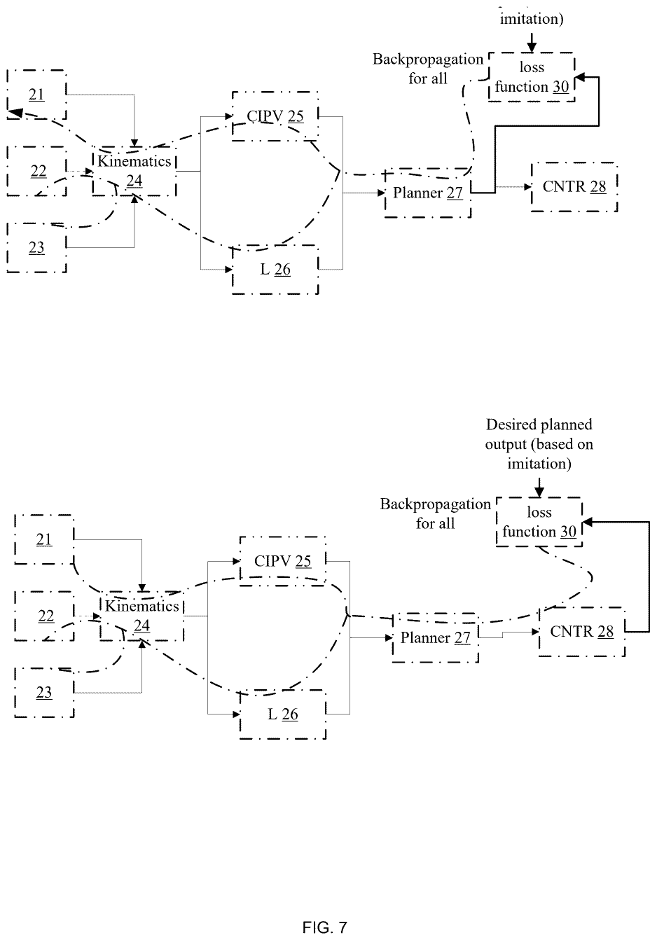

FIG. 7 illustrates examples of co-learning in which all modules are trained concurrently and are not frozen.

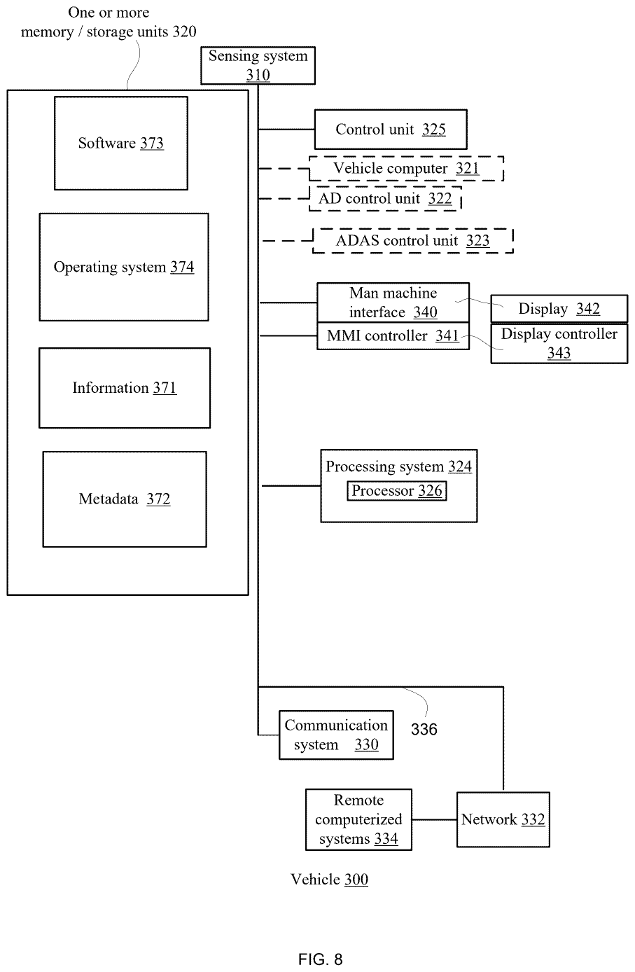

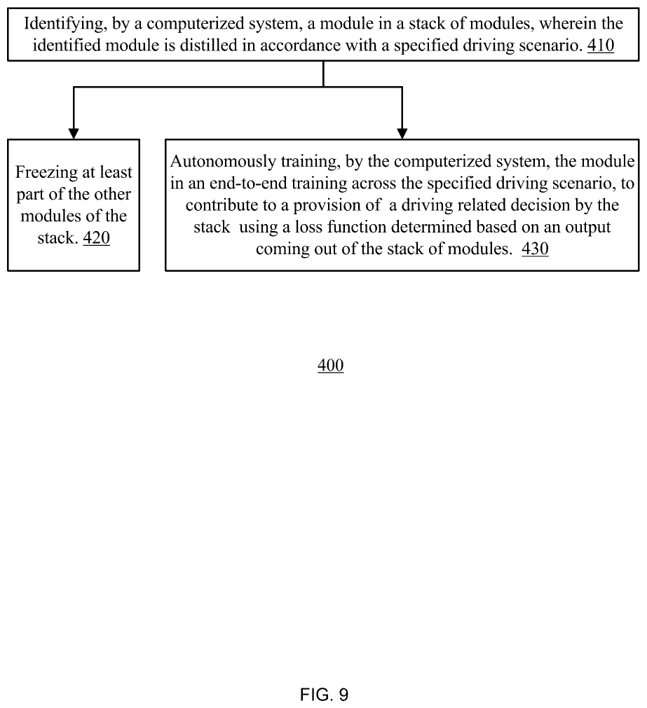

FIG. 8 illustrates an example of a computerized system 400.

FIG. 8 illustrates an example of vehicle 300 configured to utilize one or more stacks generated by method 100.

The vehicle may use the stack during the execution of method 200.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop, or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the memory and/or storage unit 320 stores at least one of: operating system 374, information 371, metadata 372, and software 373.

According to an embodiment, the processing system is configured implement the stack and generate driving related decision when executing software and/or metadata stored in the memory and/or storage unit 320.

The control unit 325 may cooperate with ADAS control unit 323 and/or with AD control unit 322 and/or may control or communicate with other vehicle components-including vehicle computer.

The ADAS control unit 323 is configured to control ADAS operations.

The AD control unit 322 is configured to control autonomous driving of the ground vehicle.

The vehicle computer 321 is configured to control the operation of the vehicle especially controlling the engine, the transmission, and any other vehicle system or component.

The vehicle computer 321 may be in communication with an engine control module, a transmission control module, a powertrain control module, and the like.

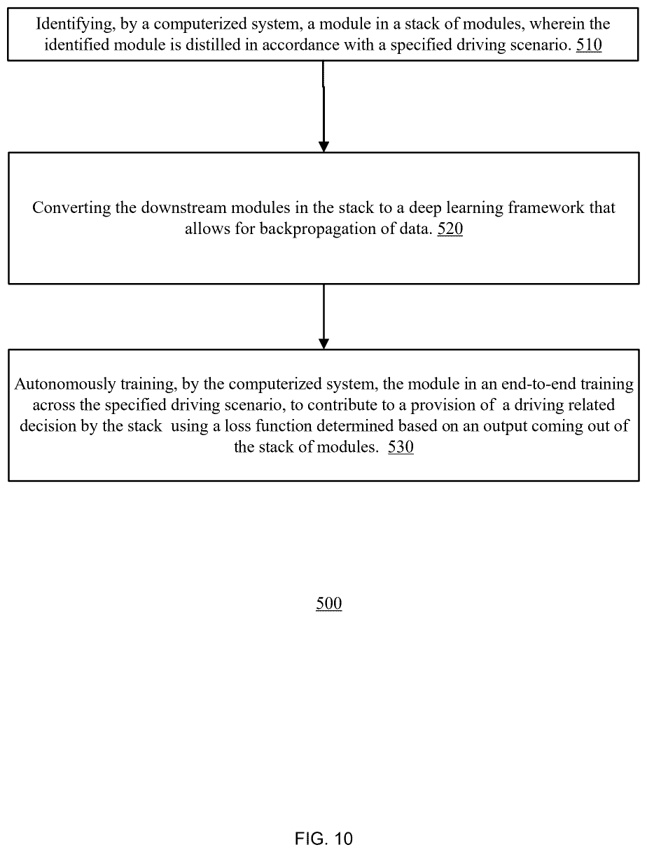

FIG. 10 illustrates an example of method 400 training of components within a system for driving.

According to an embodiment, method 400 includes step 410 of identifying a module in a stack of modules that is distilled in accordance with a driving scenario.

According to an embodiment, step 410 is followed by step 420 of freezing at least part of the other modules of the stack.

According to an embodiment, step 410 is also followed by step 430 of training the module in an end to end training within the stack, across the driving scenario, by using a loss function to contribute to a provision of a driving related decision by the stack of modules. Step 430 is executed during the freezing of step 420.

Any reference to steps 120, 130 and 140 should be applied mutatis mutandis to steps 410, 420 and 430, respectively.

FIG. 11 illustrates an example of method 500 training of components within a system for driving.

According to an embodiment, method 500 includes step 510 of identifying a module in a stack of modules that is distilled in accordance with a driving scenario. Any reference to step 120 should be applied mutatis mutandis to step 510.

According to an embodiment, step 510 is followed by step 520 of converting the downstream modules in the stack to a deep learning framework that allows for backpropagation of data. For Example—referring to FIG. 3 and assuming that the output of the loss function is propagated to module 74 backwards—then when module 71 is individually trained in the stack—modules 74, 73 and 72 are downstream modules that should be capable of backpropagating the output of the loss function without being amended themselves. For another example—referring to FIG. 3 and assuming that the output of the loss function is propagated to module 74 backwards—then when module 72 is individually trained—modules 74 and 73 are downstream modules that should be capable of backpropagating the output of the loss function without being amended themselves.

According to an embodiment, the loss function output is not fed directly to the individually trained module—but is backpropagated through one or more modules that are referred to downstream modules. There may be a need to convert these backstream modules to convey the loss function output backwards without being modified.

According to an embodiment, following the conversion, the backstream modules form a deep learning framework that allows for backpropagation of data. An example of conversion is provided in the section of the application titled Convert Rule-Based Components to PyTorch.

According to an embodiment, step 520 is followed by step 530 of training the module in an end to end training within the stack, across the driving scenario, by using a loss function to contribute to a provision of a driving related decision by the stack of modules. Any reference to step 140 should be applied mutatis mutandis to step 530.

Any reference to any one of the terms “comprise”, “comprises”, “comprising”, “include”, “including”, “includes”, “having” should be applied mutatis mutandis to “consisting” or “consists”. For example-any of the mentioned above may be limited only to steps explicitly illustrated as part of the method.

Any reference to any one of the terms “comprise”, “comprises”, “comprising”, “include”, “including”, “includes”, “having” should be applied mutatis mutandis to “consisting essentially of” or “consists essentially of”.

The term obtaining include receiving and/or generating.

Artificial intelligence is used in relation to machines that mimic human intelligence and human cognitive functions like learning and problem solving. There are three types of artificial intelligence that include artificial super intelligence, artificial narrow intelligence, and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

According to an embodiment a scenario incorporates multiple aspects of and metrics affecting implementation of a model for autonomous driving, including for example a location of the vehicle, one or more weather conditions, one or more contextual parameters, road condition, traffic parameter(s). Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of the underlying architecture or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method of training of components within a system for driving, the method comprises:
identifying, by a computerized system, a module in a stack of modules, wherein the identified module is distilled in accordance with a specified driving scenario;
freezing at least part of the other modules of the stack; and
autonomously training, by the computerized system, the module in an end-to-end training across the specified driving scenario, to contribute to a provision of a driving related decision by the stack of modules, wherein the autonomously training is by using a loss function determined based on an output coming out of the stack of modules; and
wherein the autonomously training of the module, within the stack, occurs while at the least part of the other modules of the stack are in a frozen state.

2. The method according to claim 1, wherein the identified module is distilled to a neural network, prior to the autonomously training the neural network in the stack.

3. The method according to claim 1, wherein the loss function is further determined by imitation learning of a human driving behavior facing the specified driving scenario.

4. The method according to claim 1, wherein the stack comprises a driving controller unit, and the autonomously training is by using the loss function determined based on the output coming out of the driving controller unit of the stack of modules.

5. The method according to claim 1, wherein the autonomously training is by using the loss function determined based on the output coming out of path planner module of the stack of modules.

6. The method according to claim 1, wherein the autonomously training involves backpropagating the output of the loss function through one or more downstream modules of the stack of modules till reaching the identified module.

7. The method according to claim 6, wherein the freezing comprises freezing the one or more downstream modules.

8. The method according to claim 1, further comprising distilling the identified module in accordance with the specified driving scenario, based on identified driving related data pertaining to the specified driving scenario.

9. The method according to claim 1, wherein further comprising storing parameters of the autonomously trained module in a memory unit.

10. The method according to claim 1, further comprising repeating the freezing and the autonomously training for one or more additional modules of the stack.

11. The method according to claim 10, further comprising performing co-learning between the autonomously trained module and the autonomously trained one or more additional modules of the stack.

12. A non-transitory computer readable medium of training of components within a system for driving that stores instructions that, when executable by at least one processing device of a computerized system, cause the computerized system to:
identify a module in a stack of modules, wherein the identified module is distilled in accordance with a specified driving scenario;
freeze at least part of the other modules of the stack; and
autonomously train the module in an end-to-end training across the specified driving scenario, to contribute to a provision of a driving related decision by the stack of modules, by using a loss function determined based on an output coming out of the stack of modules;
wherein the autonomously training of the module, within the stack, occurs while at the least part of the other modules of the stack are in a frozen state.

13. The non-transitory computer readable medium according to claim 1, wherein the identified module is distilled to a neural network, prior to the autonomously training the neural network in the stack.

14. The non-transitory computer readable medium according to claim 1, wherein the loss function is further determined by imitation learning of a human driving behavior facing the specified driving scenario.

15. The non-transitory computer readable medium according to claim 1, wherein the autonomously training involves backpropagating the output of the loss function through one or more downstream modules of the stack of modules till reaching the identified module.

16. The non-transitory computer readable medium according to claim 1, further storing instructions that, when executable by the at least one processing device of the computerized system, cause the computerized system to distill the identified module in accordance with the specified driving scenario, based on identified driving related data pertaining to the specified driving scenario.

17. The non-transitory computer readable medium according to claim 12, further storing instructions that, when executable by the at least one processing device of the computerized system, cause the computerized system to perform co-learning between the autonomously trained module and the autonomously trained one or more additional modules of the stack.
